(19) United States
(12) Patent Application Publication
(10) Pub. No.: US 2026/0255363 A1
(43) Pub. Date: Aug. 27, 2026

(54) REDUCING PHYSICAL DOWNLINK CONTROL CHANNEL (PDCCH) BLIND DETECTION POWER CONSUMPTION BY INCREASING VISIBILITY TO THE BLIND DECODING PROCESS

(71) Applicant: QUALCOMM Incorporated, San Diego, CA (US)

(72) Inventors: Lior UZIEL, Hod Hasharon (IL); Gabi SARKIS, San Diego, CA (US)

(21) Appl. No.: 19/060,492

(22) Filed: Feb. 21, 2025

(51) Int. Cl. H04L 1/00; H04W 72/232; H04W 72/30

(52) U.S. Cl. CPC H04W 72/232; H04W 72/30

(57) ABSTRACT

An apparatus for wireless communication has one or more processors, one or more memories coupled with the one or more processors, and instructions stored in the one or more memories and operable, when executed by the at least one processor, to cause the apparatus to obtain information having a quantity of control messages to be received in a selected slot. The instructions also cause the apparatus to blindly decode the quantity of control messages in the selected slot, in accordance with the information.

### FIELD OF THE DISCLOSURE

The present disclosure relates generally to wireless communications, and more specifically to reducing physical downlink control channel (PDCCH) blind detection power consumption by increasing visibility to the blind decoding process.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit/receive point (TRP), a new radio (NR) BS, a fifth generation (5G) Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

Aspects of the present disclosure are directed to an apparatus. The apparatus has one or more processor(s), one or more memories coupled with the one or more processors, and instructions stored in the one or more memories and operable, when executed by the one or more processors, to cause the apparatus to obtain information having a quantity of control messages to be received in a selected slot. The instructions also cause the apparatus to blindly decode the quantity of control messages in the selected slot, in accordance with the information.

Other aspects of the present disclosure are directed to an apparatus for wireless communication by a network entity. The apparatus has one or more processors, one or more memories coupled with the one or more processors, and instructions stored in the one or more memories and operable, when executed by the one or more processors, to cause the apparatus to generate information. The information has a quantity of control messages to be received in a selected slot to enable the UE to blindly decode the quantity of control messages in the selected slot, in accordance with the information.

Other aspects of the present disclosure are directed to a user equipment (UE). The UE has one or more transceivers, one or more memories having instructions; and one or more processor(s) configured to execute the instructions to cause the UE to receive, via the one or more transceivers, information having a quantity of control messages to be received in a selected slot. The instructions also cause the apparatus to blindly decode the quantity of control messages in the selected slot, in accordance with the information.

Other aspects of the present disclosure are directed to a network entity. The network entity has one or more transceivers, one or more memories having instructions; and one or more processors configured to execute the instructions to cause the network entity to transmit information to a user equipment (UE) via the one or more transceivers. The information has a quantity of control messages to be received in a selected slot to enable the UE to blindly decode the quantity of control messages in the selected slot, in accordance with the information.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a block diagram illustrating an example resource structure for wireless communication, in accordance with various aspects of the present disclosure.

FIG. 5 is a timing diagram illustrating an example associated with a first control message providing information about a quantity of control messages to be received in a selected slot, in accordance with various aspects of the present disclosure.

FIG. 6 is a flow diagram illustrating an example process performed, for example, by a wireless node, in accordance with various aspects of the present disclosure.

FIG. 7 is a flow diagram illustrating an example process performed, for example, by a network entity, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with fifth generation (5G) and later wireless technologies, aspects of the present disclosure can be applied in other generation-based communications systems, such as and including 3G and/or 4G technologies.

A control resource set (CORESET) in a slot includes time and/or frequency resources (e.g., physical resource blocks (PRBs)) that may be structured to support efficient use of resources for one or more physical downlink control channels (PDCCHs) and/or one or more physical downlink shared channels (PDSCHs). A PDCCH message, such as downlink control information (DCI), may schedule a PDSCH message for a transport block (TB). A CORESET may include one or more control channel elements (CCEs) that span a portion of the system bandwidth. A CCE may include DCI that provides control information for wireless communication. A network entity (e.g., base station) may transmit DCI during multiple CCEs, where the quantity of CCEs used for transmission of DCI represents the aggregation level (AL) used by the network entity for the transmission of DCI.

Legacy blind detection processing by a user equipment (UE) causes the UE to invest power and memory in blind detecting all search spaces, irrespective of whether and how much downlink control information (DCI) was actually transmitted to the UE. Supporting multiple transmit/receive points (TRPs), multiple carriers, and multiple-input/multiple-out (MIMO) increases the number of search spaces that a UE is required to blindly search and hence the power consumption and memory increase. Solutions are desired to reduce blind decoding efforts for active UEs, for example, UEs in an active window of transmitting or receiving data or measurements.

Aspects of the present disclosure enhance existing technology by providing UEs with knowledge of DCI messages, which may be received in a same or subsequent slot from a current slot or a same or different component carrier (CC). More specifically, the DCI message may be in a same slot and same CC, future slot and same CC, same slot and different CC, and future slot and different CC. UEs may be informed not only of where to search, but also of what is to be received in a particular slot, thereby reducing a number of searches. For example, UEs may be notified of a quantity of DCI messages to be received by the UE, and a fallback mode of the DCI messages. Aspects also specify complementary messages and processes, for example, introduction of additional processes, pre-configured broadcast allocation for notification DCI messages, and introduction of a linking method between a list of received DCI messages.

The knowledge imparted to the UEs may include information describing attributes of all relevant DCI messages or specific individual DCI messages. Attributes may include, for example, a quantity of DCI messages to be received, whether DCI messages are fallback DCI messages or non-fallback DCI messages, and resource allocations. Fallback DCI formats are smaller than non-fallback formats and because the blind detection depends on the size, then blind detection is carried out twice unless there is knowledge of whether a DCI message is fallback or non-fallback.

Particular aspects of the subject matter described in this disclosure can be implemented to realize one or more of the following potential advantages. In some examples, the described techniques, such as obtaining information about control messages to be received in a selected slot may reduce power consumption, reduce processing, and reduce memory utilization.

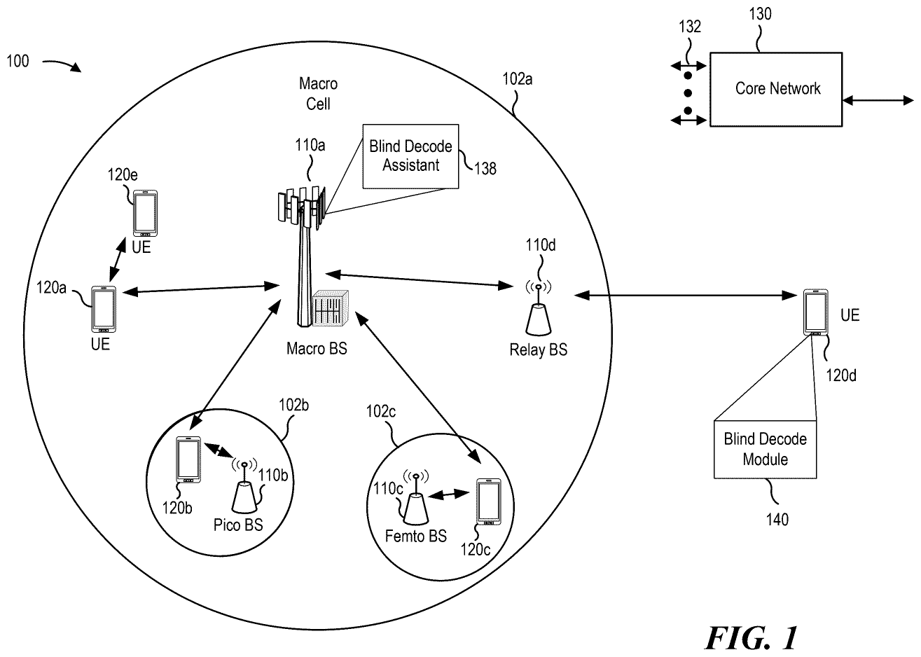

FIG. 1 is a diagram illustrating a wireless communications network 100 in which aspects of the present disclosure may be practiced. Generally, the wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, the wireless communications network 100 includes terrestrial aspects, such as ground-based network entities (e.g., BSs 110), and non-terrestrial aspects, such as satellite and aircraft, which may include network entities on-board (e.g., one or more BSs) capable of communicating with other network elements (e.g., terrestrial BSs) and user equipment.

The wireless communications network 100 may be a 5G or new radio (NR) network or some other wireless network, such as a long term evolution (LTE) network. The wireless communications network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit/receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless communications network 100 through various types of backhaul interfaces such as a direct physical connection, a virtual network, and/or the like using any suitable transport network.

The wireless communications network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless communications network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless communications network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless communications network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless communications network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include a blind decode module 140. For brevity, only one UE 120d is shown as including the blind decode module 140. The blind decode module 140 may obtain information having a quantity of control messages to be received in a selected slot. The blind decode module 140 may blindly decode the quantity of control messages in the selected slot, in accordance with the information.

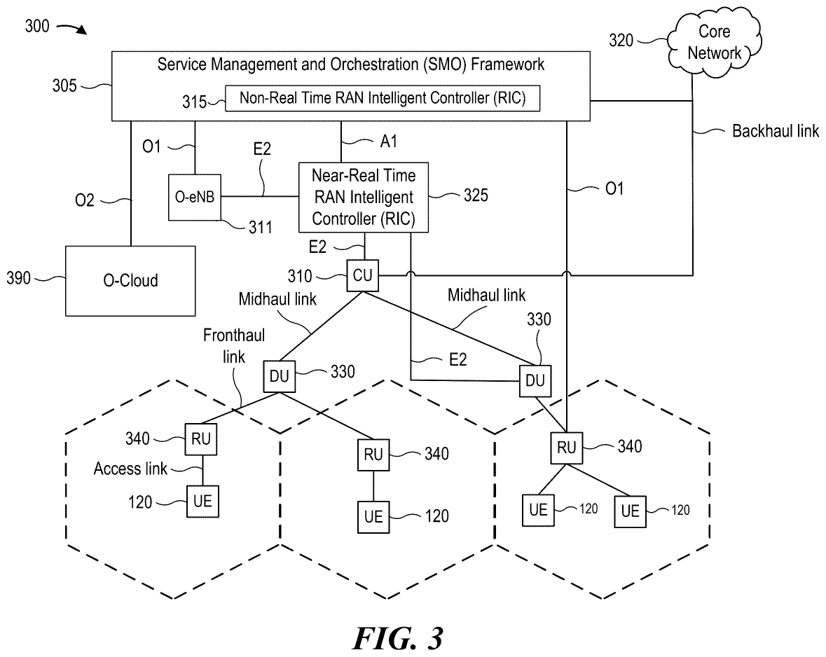

The core network 130 or the base stations 110 or any other network device (e.g., as seen in FIG. 3) may include a blind decode assistant 138. For brevity, only one base station 110a is shown as including the blind decode assistant 138. The blind decode assistant 138 may generate information having a quantity of control messages to be received in a selected slot to enable the UE to blindly decode the quantity of control messages in the selected slot, in accordance with the information.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order from what is described.

As indicated above, FIG. 1 is provided merely as an example. Other examples may differ from what is described with regard to FIG. 1.

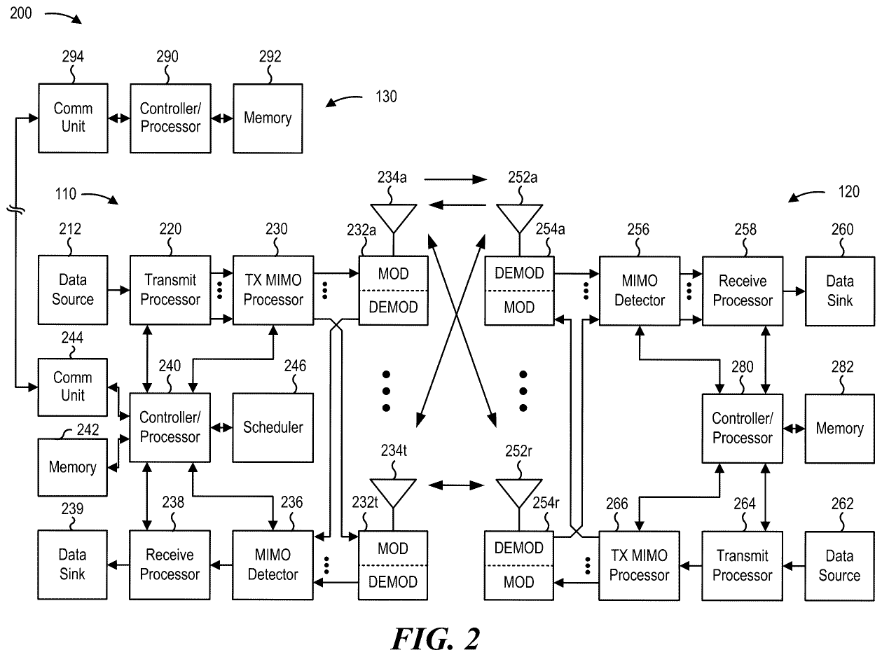

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

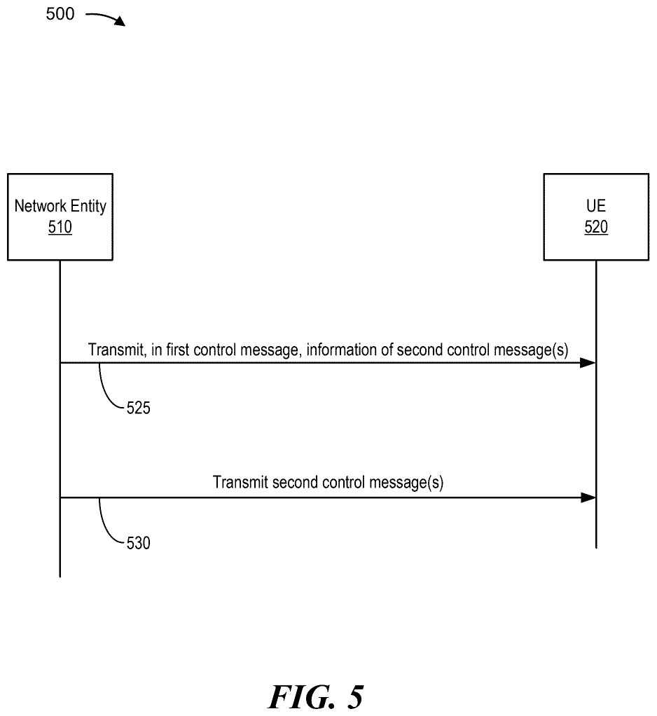

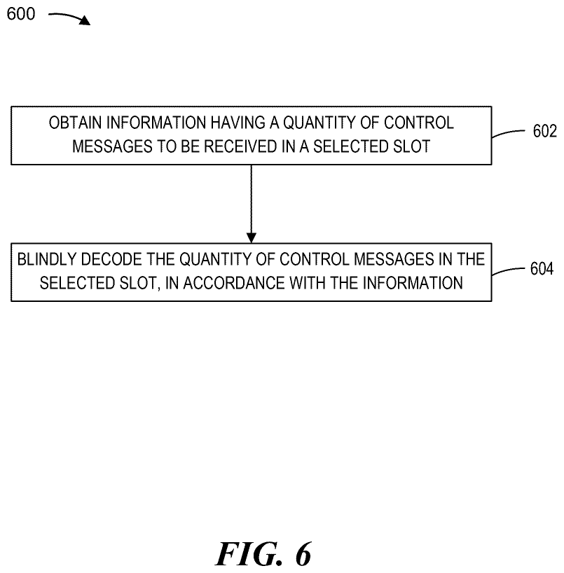

The controller/processor 240 of the base station 110, the controller/processor 280 of the UE 120, and/or any other component(s) of FIG. 2 may perform one or more techniques associated with reducing blind decode power consumption, as described in more detail elsewhere. For example, the controller/processor 240 of the base station 110, the controller/processor 280 of the UE 120, and/or any other component(s) of FIG. 2 may perform or direct operations of, for example, the processes of FIGS. 5 and 6 and/or other processes as described. Memories 242 and 282 may store data and program codes for the base station 110 and UE 120, respectively. A scheduler 246 may schedule UEs for data transmission on the downlink and/or uplink.

In some aspects, the UE 120 and/or base station 110 may include means for obtaining, means for blindly decoding, means for reverting, and means for generating. The UE 120 and/or base station 110 may include the transceivers 254, controller/processor 280, and/or antenna(s) 252 of the UE 120 illustrated in FIG. 2 and/or transceiver 232, controller processor 240 and antenna 234 of the network entity 110 in FIG. 2. Such means may include one or more additional components of the UE 120 or base station 110 described in connection with FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation, and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

As indicated above, FIG. 3 is provided as an example. Other examples may differ from what is described with regard to FIG. 3.

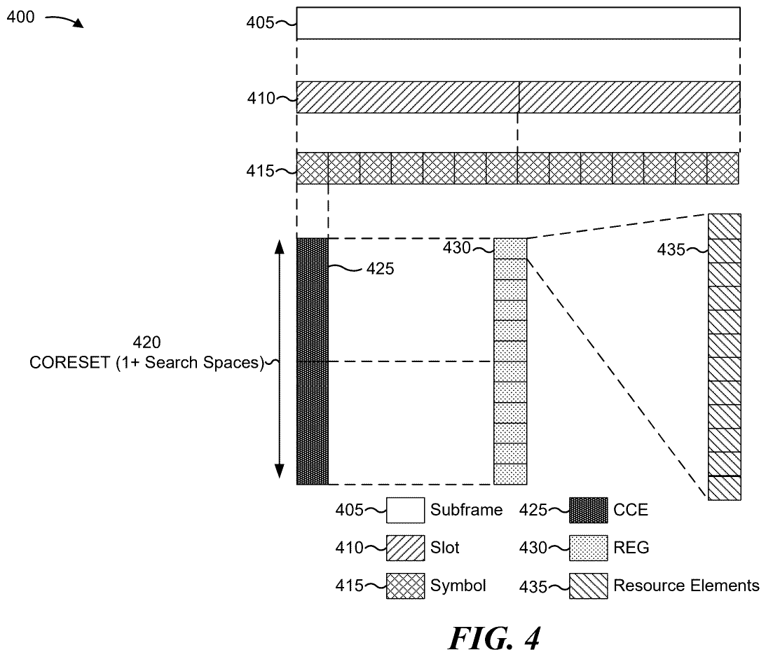

FIG. 4 is a block diagram illustrating an example resource structure 400 for wireless communication, in accordance with various aspects of the present disclosure. A resource structure 400 shows an example of various groups of resources. As shown, the resource structure 400 may include a subframe 405. The subframe 405 may include multiple slots 410. While the resource structure 400 is shown as including two slots 410 per subframe 405, a different number of slots may be included in a subframe (e.g., 4 slots, 8 slots, 16 slots, 32 slots, or another quantity of slots). In some aspects, different types of transmission time intervals (TTIs) may be used, other than subframes and/or slots. A slot 410 may include multiple symbols 415, such as 14 symbols per slot.

The potential control region of a slot 410 may be referred to as a control resource set (CORESET) 420 and may be structured to support efficient use of resources, such as by flexible or dynamic configuration or reconfiguration of resources of the CORESET 420 for one or more physical downlink control channels (PDCCHs). There may be multiple CORESETs for a UE. That is, between 0 (e.g., no control is sent) and N CORESETs may be allocated in the slot. The quantity of CORESETs a UE is required to handle in a slot is limited, but the base station is not limited as the base station handles multiple UEs. In some aspects, the CORESET 420 may occupy the first symbol 415 of a slot 410, the first two symbols 415 of a slot 410, or the first three symbols 415 of a slot 410. Thus, a CORESET 420 may include multiple resource blocks (RBs) in the frequency domain, and either one, two, or three symbols 415 in the time domain. In 5G, a quantity of resources included in the CORESET 420 may be flexibly configured. For example, radio resource control (RRC) signaling may indicate a frequency domain region (e.g., a quantity of resource blocks) and/or a time domain region (e.g., a quantity of symbols) for the CORESET 420.

As illustrated, a symbol 415 that includes the CORESET 420 may include one or more control channel elements (CCEs) 425, shown as two CCEs 425 as an example, that span a portion of the system bandwidth. A CCE 425 may include downlink control information (DCI) that provides control information for wireless communication. A network entity (e.g., gNB) may transmit DCI in multiple CCEs 425 (as shown), where the quantity of CCEs 425 used for transmission of DCI represents the aggregation level (AL) used by the network entity for the transmission of DCI. In FIG. 4, an aggregation level of two is shown as an example, corresponding to two CCEs 425 in a slot 410. In some aspects, different aggregation levels may be used, such as 1, 2, 4, 8, 16, or another aggregation level.

Each CCE 425 may include a fixed quantity of resource element groups (REGs) 430, shown as six REGs 430, or may include a variable quantity of REGs 430. In some aspects, the quantity of REGs 430 included in a CCE 425 may be specified by a REG bundle size. A REG 430 may include one resource block, which may include twelve resource elements (REs) 435 within a symbol 415. A resource element 435 may occupy one subcarrier in the frequency domain and one orthogonal frequency division multiplexing (OFDM) symbol in the time domain.

A search space may include all possible locations (e.g., in time and/or frequency) where a PDCCH may be located. A CORESET 420 may include one or more search spaces, such as a UE-specific search space, a group-common search space, and/or a common search space. A search space may indicate a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for multiple UEs) and/or an aggregation level being used. A possible location (e.g., in time and/or frequency) for a PDCCH may be referred to as a PDCCH candidate, and the set of all possible PDCCH locations at an aggregation level may be referred to as a search space. For example, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space. One or more search spaces across aggregation levels may be referred to as a search space (SS) set.

A CORESET 420 may be interleaved or non-interleaved. An interleaved CORESET 420 may have CCE-to-REG mapping such that adjacent CCEs are mapped to scattered REG bundles in the frequency domain (e.g., adjacent CCEs are not mapped to consecutive REG bundles of the CORESET 420). A non-interleaved CORESET 420 may have a CCE-to-REG mapping such that all CCEs are mapped to consecutive REG bundles (e.g., in the frequency domain) of the CORESET 420.

The PDCCH is mapped to 1/2/4/8/16 CCEs according to the AL to increase reception. The PDCCH may map to greater than 16 CCEs, such as 32 CCEs. Each CCE includes 6 REGs, and each REG includes 12 REs in one OFDM symbol (single physical resource block (PRB)). The PDCCH-DMRS (demodulation reference signal) occupies one-fourth of the REs (e.g., subcarriers 1, 5, 9). The PDCCH is quadrature phase shift keying (QPSK) modulated (2-bit constellation). Therefore, each CCE includes 108 coded bits (6[REGs]*12[REs]*¾[non-DMRS]*2[QPSK]). The larger the DCI payload and the worse the channel conditions, the larger the AL that will be specified. An acceptable number from current LTE and initial NR deployments (non-massive multiple-input multiple-output (MIMO)) is AL=4. The PDCCH consumes 4 CCEs on average.

For 100 megahertz (MHz) bandwidth in 30 kilohertz (kHz) (e.g., 273 PRBs), the number of available CCEs depends on the number of symbols in the CORESET (1/2/3), and the AL (1/2/4/8/16). For an AL of 4, the number of DCI messages is 11/22/34 using 1/2/3 symbols for control, thus sacrificing ~21/14/7% of the DL resources of a full DL slot. For 1/2/3 symbols, the number of DCI messages may be 45/91/137 for an AL of 1, 22/45/68 for an AL of 2, 5/11/17 for an AL of 8, and 2/5/8 for an AL 16.

A PDCCH message may include DCI for scheduling a PDSCH message of a transport block. One or more fields in the PDCCH message may include a modulation and coding scheme (MCS), an allocation, and/or ports, where retransmission DCI messages are blind decoded by the UE (with false alarms and misdetection probabilities). In order to notify the UE of reception of the PDSCH or transmission of physical uplink shared channel (PUSCH), a DCI message is sent to the UE The UE blind searches the DCI messages, and if found, is aware of the reception or the transmission.

For frequency division duplex (FDD) or time division duplex (TDD) with no uplink centric downlink-uplink (DL-UL) ratio, the number of DCI messages that are specified is equal to a sum of a number of scheduled DL UEs and a number of scheduled DL UEs. For TDD with an uplink centric DL-UL ratio, the number of specified DCI messages may be a sum of the number of scheduled DL UEs and a multiple of the number of scheduled DL UEs (per UL-DL ratio). A UE may neglect broadcasts and other general control messages (e.g., DCI messages with a non-cell radio network temporary identifier). A massive MIMO network entity may support greater than eight layers (e.g., 16) and may be required to support 64 DL and 64 UL scheduled UEs per slot for a bandwidth of 100 MHz.

For the FDD use case, the number of required DCI messages is 128, where the available resources are sufficient (137) only with AL=1 and only when sacrificing 21% (3 symbols) of the DL resources. For TDD with an UL centric DL-UL ratio, this gap in resources would be even greater. A scheduler may not find an available CCE for transmitting PDCCH messages to the UE. There may also be a lack of signaling resources. Even if all signaling resources are used, the amount of signaling resources is still lower than what is required of the PDCCH.

As indicated above, FIG. 4 is provided as an example. Other examples may differ from what is described with respect to FIG. 4.

Legacy blind detection processing by a UE causes the UE to invest power and memory in blind detecting all search spaces, irrespective of whether and how much downlink control information (DCI) was actually transmitted to the UE. Supporting multiple transmit/receive points (TRPs), multiple carriers, and multiple-input/multiple-out (MIMO) increases the number of search spaces that a UE is required to blindly search and hence the power consumption and memory increase. Solutions are desired to reduce blind decoding efforts for active UEs, for example, UEs in an active window of transmitting or receiving data or measurements.

Aspects of the present disclosure enhance existing technology by providing UEs with knowledge of additional DCI messages to be received in a subsequent slot or different component carrier (CC). UEs may be informed not only of where to search, but also of what is to be received in a particular slot, thereby reducing a number of searches. For example, UEs may be notified of a quantity of DCI messages to be received by the UE, and a fallback mode of the DCI messages. Aspects also specify complementary messages and processes, for example, introduction of additional processes, pre-configured broadcast allocations for notification DCI messages, and introduction of a linking method between a list of received DCI messages.

The knowledge imparted to the UEs may include information describing attributes of all relevant DCI messages. Attributes may include, for example, a quantity of DCI messages to be received and whether DCI messages are all fallback DCI messages, or all non-fallback DCI messages. For example, if only three DCI messages are to be received, the UE may stop searching after receiving the third DCI. Fallback DCI messages are smaller than non-fallback DCI messages. The search may be improved based on knowing the size of the DCI messages, reducing blind decoding by 50%. That is, there may be 22 options for fallback DCI messages and 22 options for non-fallback DCI messages. If the UE knows only fallback DCI messages are to be received, only 22 options are considered.

The knowledge may also provide information describing attributes of a particular DCI. For example, the knowledge of an allocation for an individual DCI may be indicated, such as the number of bits per mode of indication or the exact candidate location. A single bit may indicate whether any particular DCI is a fallback DCI or a non-fallback DCI.

The techniques of the present disclosure reduce UE power consumption, processing, and memory utilization. The knowledge of the number of relevant DCI messages to be received in a slot limits the blind decodes up to the number of received DCI messages. For example, assume 44 candidates for three DCI messages. If candidates 4, 9, and 20 include the three DCI messages, then the UE can stop searching after blind decode 20. Thus, the UE saves processing and battery consumption associated with the blind detection for the candidates remaining after the last DCI was received. In case of a misdetection, however, no savings is achieved. If no DCI messages are to be received (e.g., quantity=0), the UE may shut down for the duration of the symbols or slot, saving processing and battery consumption that would otherwise be used for detection.

The knowledge of allocations of relevant DCI messages to be received in a slot (e.g., the DCI messages are located in candidate locations 3, 6, and 10) allows the UE to decode only in the provided allocations, irrespective of whether the DCI messages were successfully detected.

UEs that receive information on whether a control message is a non-fallback or fallback type reduce a number of blind decodes by a factor of two because no hypothesis of the DCI payload size is needed. This is true whether the knowledge is general information on all DCI messages, or specific to each DCI message. The knowledge of general attributes of all relevant DCI messages in a slot, for example, that the DCI messages are not a mixed combination of fallback and non-fallback DCI messages, reduces the number of blind decodes by a factor of two from the first decoded DCI. For example, if the information provided about all the DCI messages that are to be blind decoded in the slot indicates the DCI messages are not mixed fallback and non-fallback DCI messages, then the UE would process in the following manner: until the reception of the first detected DCI message, it is not known whether the DCI messages are all non-fallback, or are all fallback. Thus, the UE blind decodes both hypothesis (e.g., two sizes) until detecting the first DCI message. Once the first DCI message is detected, the UE knows which hypothesis was correct-fallback or non-fallback. From that moment on and until the end of the slot, the UE only detects with one of the options in accordance with the first DCI message.

According to aspects of the present disclosure, information describing attributes of all relevant DCI messages is provided in a broadcast DCI at a pre-configured location. The broadcast DCI may be a DCI message of type 2_1, 2_3, etc., as opposed to a UE specific unicast DCI message. The information in the broadcast DCI indicates a quantity or number of DCI messages to be received. For example, the broadcast DCI may have a format: <UEID, #DCI> for the UE identifier (ID) to be receiving the DCI messages, where #DCI is the quantity of DCI messages transmitted to the UE having the UE ID. In some implementations, the number of DCI messages (#DCI) is a field with two or three bits, thereby indicating between one to four or one to eight DCI messages. In these implementations, a UE that is not expecting DCI messages will not be included in the broadcast DCI. It is noted that the terms “defined” is intended to capture the concepts of “pre-defined” “pre-configured” or “dynamically defined.”

In other aspects of the present disclosure, the information describing the attributes of all relevant DCI indicates whether or not DCI messages are all non-fallback DCI messages, and may be in the format: <UE_{ID}, is-fallback>, where is-fallback is a single bit. Alternatively, the information describing the attributes of all relevant DCI messages indicates whether DCI messages are mixed fallback and non-fallback DCI messages and may be in the format: <UE_{ID}, is-mixed-fallback>, where is-mixed-fallback is a single bit.

In still further aspects, the information may include any combination of the previously described attributes. For example, by combining the number of DCI messages and the fallback or not information, the format may be as follows: <UE_{ID}, #DCI, is-fallback>. In some aspects, rather than indicating the UE ID in the broadcast message, a UE may be explicitly configured with an index for a group of fields to read.

In other aspects of the present disclosure, information describing attributes of each DCI is provided in a broadcast DCI at a pre-configured location for each CORESET. This information may indicate the number and allocation of all DCI messages, for example in the format: #DCI, <CCE, AL>, where CCE is the control channel element and AL is the aggregation level. Each UE blind detects candidates that fit the allocation provided. In still other aspects, the information in the broadcast DCI indicates the number and allocation of all DCI messages for each UE, for example in the format: #DCI, <UE_{ID}, Candidate>, where Candidate is the candidate location. Similar to as described above, rather than indicating the UE ID in the broadcast DCI, a UE may be explicitly configured with an index for a group of fields to read. Moreover, when the UE does not detect the broadcast DCI during a time period, the UE reverts to legacy blind decoding techniques.

According to aspects of the present disclosure, information describing attributes of all relevant DCI messages is duplicated in each received DCI that is unicast to the UE. The information may indicate the total number of DCI messages, where the total number includes the already received unicast DCI. Such information may be provided in two or three bits, thereby indicating between one to four or one to eight DCI messages, respectively. The information may indicate the number of DCI messages and whether the rest of the DCI messages are the same as the received DCI with respect to fallback. For example, a single bit (e.g., is-same-fallback) may indicate whether the rest of the DCI messages are the same fallback/non-fallback type as the received DCI.

According to further aspects of the present disclosure, information describing attributes of each DCI is duplicated in each received DCI for the UE. The information may indicate the number and allocation of the rest of the DCI messages. Example formats are: #DCI, <CCE, AL> or #DCI, <Candidate>, where the information for the #DCI (e.g., DCI 3) is provided in CCE start allocation (which is a number limited by the number of CCEs in the CORESET) and the AL (e.g., the size of the DCI can be 1, 2, 3, 8, or 16 CCEs). The information may also indicate the number of DCI messages and list their fallback indicators. An example format for the duplicated information is <#DCI, fallback>, where the number of DCI messages (e.g., #DCI field) may be two to three bits, and the fallback list (e.g., fallback) may be one to four or one to eight bits and individually indicates whether or not each DCI is a fallback DCI. For example, six DCI messages may be specified with each DCI indicated to be either a fallback DCI or non-fallback DCI. Alternatively, the information may provide the number of DCI messages, their allocation, and their fallback indicators. An example format is: #DCI <CCE, AL, fallback>.

According to still further aspects of the present disclosure, the information describing attributes of each DCI is provided in each received DCI, which links to a following DCI for the UE. The following DCI may also be in a subsequent slot or in a different component carrier (CC). These aspects are an alternative to duplicating the information in each DCI. With linking, the information may provide an allocation of the next DCI, for example in the format: Candidate. In other aspects, the information provides an allocation and fallback indicators. An example format of linking DCI is: Candidate, fallback. In still further aspects, the information provides the number of all DCI messages and an allocation of the next DCI. The message format may be: #DCI, Candidate. In other aspects, the information provides the total number of all DCI messages, the allocation, and a fallback indicator for the next DCI. An example format may be: #DCI, Candidate, fallback.

The first DCI to be linked to the following DCI messages is either blind detected or pre-notified. Pre-notification may be received in previous slots for that UE (only indicating the allocation). If another CC was mentioned then this is also a possibility (even in a same CC if there is a known order for receiving the DCI messages by CCs (for example, in the case where a smaller CC index is searched before a higher CC index). This pre-notification is similar to duplicating the information describing attributes of all relevant DCI messages, except the information applies only to a single, first DCI in the future slot. Information can be received for the first DCI to reduce blind decoding, for example, the number and/or fallback/non-fallback designation. Without the information, the first DCI in an active window will consume power associated with a blind decode operation. In alternative aspects, the first DCI may be a broadcasted DCI at a pre-configured location. This is similar to receiving information for each DCI in a broadcast DCI at a pre-configured location in accordance with a CORESET, as previously described. However, in this case, only a single, first DCI in the slot is indicated, for example in the format: #DCI, <UE_{ID}, first Candidate only>, where first Candidate only indicates the allocation for the first DCI.

FIG. 5 is a timing diagram illustrating an example 500 associated with a first control message providing information about a quantity of control messages to be received in a selected slot, in accordance with various aspects of the present disclosure. As shown in FIG. 5, a network entity 510 (e.g., base station 110) and a UE 520 (e.g., UE 120) may communicate with one another via a wireless network (e.g., wireless communications network 100).

According to various aspects described, a first control message (e.g., first PDCCH message or first DCI) may indicate a quantity of control messages to be received in a selected slot or component carrier. The information from the network entity 510 may reduce blind detection processing at the UE 520 by preventing blind detection that would otherwise require the processing of all candidates. As a result, power is conserved at the UE 520. The power savings may be significant as the number of search spaces increases with the number of component carriers (CCs), the number of layers, and the number of multiple TRPs.

The information may be received in a control message broadcast to multiple UEs or a control message unicast to an individual UE. The information may be pertinent to all relevant control messages or may be specific to each individual control message. The information may additionally indicate whether a control message is a fallback DCI or a non-fallback DCI, and/or may indicate an allocation.

The example 500 shows a transmission, by the network entity 510, of a first control message that provides information for a second or multiple control messages at time 525. At time 530, the network entity 510 may transmit the second control message(s). The second control message(s) can be decoded by the UE 520 more quickly than with conventional blind decoding, due to the information received in the first control message. The second control message may follow the first control message in a slot that is later than a slot of the first control message or be in a different CC. For example, the first control message may be in slot N, and the consecutive second control message is in slot N+K, where K is greater than 0. K may be 1, or K may be greater than 1. In some aspects, the control messages may include DCI messages.

As indicated above, FIG. 5 is provided as an example. Other examples may differ from what is described with respect to FIG. 5.

As indicated above, FIGS. 3-5 are provided as examples. Other examples may differ from what is described with respect to FIGS. 3-5.

FIG. 6 is a flow diagram illustrating an example process 600 performed, for example, by a wireless node, in accordance with various aspects of the present disclosure. The example process 600 is an example of reducing physical downlink control channel (PDCCH) blind detection power consumption by increasing visibility to the blind decoding process. The operations of the process 600 may be implemented by a UE 120.

At block 602, the user equipment (UE) obtains information having a quantity of control messages to be received in a selected slot. For example, the UE (e.g., using the antenna 252, DEMOD/MOD 254, MIMO detector 256, receive processor 258, controller/processor 280, memory 282, and/or the like) may obtain the information. In some aspects, the information is obtained via a control message intended for a plurality of UEs. In other aspects, the information is obtained via a unicast control message. In still other aspects, the information is obtained via a broadcast control message at a defined location or via an index indicating a group of fields to be decoded. In yet other aspects, the information is obtained via a control message and is linked to another control message.

At block 604, the user equipment (UE) blindly decodes the quantity of control messages in the selected slot, in accordance with the information. For example, the UE (e.g., using the controller/processor 280, memory 282, and/or the like) may blindly decode the quantity of control messages. The information may indicate whether the quantity of control messages to be received in the selected slot are fallback control messages or non-fallback control messages, may indicate whether the control messages corresponding to the quantity of control messages are fallback and non-fallback control messages, and/or may indicate whether the information comprises an allocation of control messages or an indication of candidate control messages.

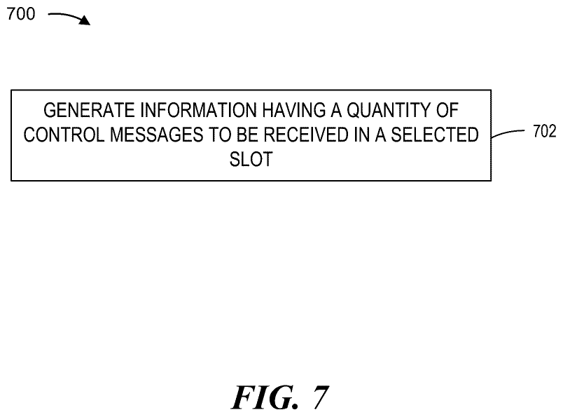

FIG. 7 is a flow diagram illustrating an example process 700 performed, for example, by a network entity, in accordance with various aspects of the present disclosure. The example process 700 is an example of reducing physical downlink control channel (PDCCH) blind detection power consumption by increasing visibility to the blind decoding process. The operations of the process 700 may be implemented by a network entity, such as the base station 110.

At block 702, the base station generates information having a quantity of control messages to be received in a selected slot. The information enables the UE to blindly decode the quantity of control messages in the selected slot, in accordance with the information. For example, the base station (e.g., using the antenna 234, MOD/DEMOD 232 TX MIMO processor 230, transmit processor 220, controller/processor 240, memory 242, and/or the like) may transmit the information. In some aspects, the information is transmitted via a control message intended for a plurality of UEs. In other aspects, the information is transmitted via a unicast control message. In still other aspects, the information is transmitted via a broadcast control message at a defined location or via an index indicating a group of fields to be decoded. In yet other aspects, the information is transmitted via a control message and is linked to another control message.

### Example Aspects

Aspect 1: A method for wireless communication at a wireless node (e.g., a UE), comprising: obtaining information comprising a quantity of control messages to be received in a selected slot; and blindly decoding the quantity of control messages in the selected slot, in accordance with the information.

Aspect 2: The method, wherein the information is obtained via a control message intended for a plurality of UEs, in accordance with Aspect 1.

Aspect 3: The method, wherein the information is obtained via a unicast control message, in accordance with Aspect 1.

Aspect 4: The method, wherein the information indicates whether the quantity of control messages to be received in the selected slot are fallback control messages or non-fallback control messages in accordance with any one of Aspects 1-3.

Aspect 5: The method, wherein the information indicates whether the control messages corresponding to the quantity of control messages are fallback and non-fallback control messages in accordance with any one of Aspects 1-4.

Aspect 6: The method, wherein the information further comprises an allocation of control messages or an indication of candidate control messages in accordance with any one of Aspects 1-5.

Aspect 7: The method, wherein the information is obtained via a broadcast control message at a defined location in accordance with any one of Aspects 1 or 4-6.

Aspect 8: The method, wherein the defined location is associated with a control resource set (CORESET) in accordance with Aspect 7.

Aspect 9: The method, wherein the information is obtained via an index indicating a group of fields to be decoded in accordance with any one of Aspects 1 or 4-6.

Aspect 10: The method, further comprising reverting to blind decoding in response to not obtaining, during a time period, a broadcast control message in accordance with any one of Aspects 1-9.

Aspect 11: The method, wherein the information is obtained via a first control message and further comprising obtaining a second control message that also comprises the information in accordance with any one of Aspects 1, 4-6, or 10.

Aspect 12: The method, wherein the information is obtained via a control message and is linked to another control message in accordance with any one of Aspects 1, 4-6, or 10.

Aspect 13: The method, wherein the control message comprises downlink control information (DCI) in accordance with Aspect 12.

Aspect 14: A method for wireless communication at a wireless node (e.g., a network entity), comprising: generating information comprising a quantity of control messages to be received in a selected slot to enable the UE to blindly decode the quantity of control messages in the selected slot, in accordance with the information.

Aspect 15: The method, wherein the information is generated for at least one of a control message intended for a plurality of UEs, an index indicating a group of fields to be decoded, a unicast control message, a broadcast control message at a defined location, or a control message linked to another control message, in accordance with Aspect 14.

Aspect 16: The method, wherein the defined location is associated with a control resource set (CORESET), in accordance with Aspect 15.

Aspect 17: The method, wherein the control message linked to another control message comprises downlink control information (DCI), in accordance with any one of Aspect 15.

Aspect 18: The method, wherein the information indicates at least one of whether the quantity of control messages to be received in the selected slot are fallback control messages or non-fallback control messages, or wherein the information indicates whether the control messages corresponding to the quantity of control messages are fallback and non-fallback control messages, in accordance with any one of Aspects 14-17.

Aspect 19: The method, wherein the information further comprises an allocation of control messages or an indication of candidate control messages, in accordance with any one of Aspects 14-18.

Aspect 20: The method, wherein the information is generated for a first control message and the method further comprises generating a second control message that also comprises the information, in accordance with any one of Aspects 14-19.

Aspect 21: An apparatus, comprising: at least one memory comprising executable instructions; and one or more processors configured to execute the executable instructions and cause the apparatus to perform a method in accordance with any one of Aspects 1-20.

Aspect 22: An apparatus, comprising means for performing a method in accordance with any one of Aspects 1-20.

Aspect 23: A non-transitory computer-readable medium comprising executable instructions that, when executed by one or more processors of an apparatus, cause the apparatus to perform a method in accordance with any one of Aspects 1-20.

Aspect 24: A computer program product embodied on a computer-readable storage medium comprising code for performing a method in accordance with any one of Aspects 1-20.

Aspect 25: A wireless node (e.g., a user equipment (UE)), comprising at least one transceiver; at least one memory comprising instructions; and at least one processor configured for performing a method in accordance with any one of Aspects 1-13, wherein the at least one transceiver is configured to: receive the information comprising a quantity of control messages to be received in a selected slot.

Aspect 26: A wireless node (e.g., a network entity), comprising at least one transceiver; at least one memory comprising instructions; and at least one processor configured for performing a method in accordance with any one of Aspects 14-20, wherein the at least one transceiver is configured to: transmit the information comprising a quantity of control messages to be received in a selected slot to enable the UE to blindly decode the quantity of control messages in the selected slot, in accordance with the information.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. An apparatus for wireless communication, comprising:
at least one processor;
at least one memory coupled with the at least one processor; and
instructions stored in the at least one memory and operable, when executed by the at least one processor, to cause the apparatus to:
obtain information comprising a quantity of control messages to be received in a selected slot; and
blindly decode the quantity of control messages in the selected slot, in accordance with the information.

2. The apparatus of claim 1, wherein the information is obtained via a control message intended for a plurality of UEs.

3. The apparatus of claim 1, wherein the information is obtained via a unicast control message.

4. The apparatus of claim 1, wherein the information indicates whether the quantity of control messages to be received in the selected slot are fallback control messages or non-fallback control messages.

5. The apparatus of claim 1, wherein the information indicates whether the control messages corresponding to the quantity of control messages are fallback and non-fallback control messages.

6. The apparatus of claim 1, wherein the information further comprises an allocation of control messages or an indication of candidate control messages.

7. The apparatus of claim 1, wherein the information is obtained via a broadcast control message at a defined location.

8. The apparatus of claim 7, wherein the defined location is associated with a control resource set (CORESET).

9. The apparatus of claim 1, wherein the information is obtained via an index indicating a group of fields to be decoded.

10. The apparatus of claim 1, wherein the at least one processor is further configured to cause the apparatus to revert to blind decoding in response to not obtaining, during a time period, a broadcast control message.

11. The apparatus of claim 1, wherein the information is obtained via a first control message and the at least one processor is further configured to cause the apparatus to obtain a second control message that also comprises the information.

12. The apparatus of claim 1, wherein the information is obtained via a control message and is linked to another control message.

13. The apparatus of claim 12, wherein the control message comprises downlink control information (DCI).

14. An apparatus for wireless communication at a network entity, comprising:
at least one processor;
at least one memory coupled with the at least one processor; and
instructions stored in the at least one memory and operable, when executed by the at least one processor, to cause the apparatus to:
generate information comprising a quantity of control messages to be received in a selected slot to enable the UE to blindly decode the quantity of control messages in the selected slot, in accordance with the information.

15. The apparatus of claim 14, wherein the information is generated for at least one of a control message intended for a plurality of user equipment (UEs), an index indicating a group of fields to be decoded, a unicast control message, a broadcast control message at a defined location, or a control message linked to another control message.

16. The apparatus of claim 15, wherein the defined location is associated with a control resource set (CORESET).

17. The apparatus of claim 15, wherein the control message linked to another control message comprises downlink control information (DCI).

18. The apparatus of claim 14, wherein the information indicates at least one of whether the quantity of control messages to be received in the selected slot are fallback control messages or non-fallback control messages, or wherein the information indicates whether the control messages corresponding to the quantity of control messages are fallback and non-fallback control messages.

19. The apparatus of claim 14, wherein the information further comprises an allocation of control messages or an indication of candidate control messages.

20. The apparatus of claim 14, wherein the information is generated for a first control message and the at least one processor is further configured to cause the apparatus to generate a second control message that also comprises the information.
